(19) United States
(12) Patent Application Publication
(10) Pub. No.: US 2009/0056495 A1
(43) Pub. Date: Mar. 5, 2009

(54) BICYCLE HANDLEBAR ASSEMBLY

(76) Inventors: Todd Bischoff, Sun Prairie, WI (US); Barry Lewis, Waterloo, WI (US)

Correspondence Address: BOYLE FREDRICKSON S.C., 840 North Plankinton Avenue, MILWAUKEE, WI, 53203, US

(21) Appl. No.: 11/845,281

(22) Filed: Aug. 27, 2007

(51) Int. Cl. B62K 21/12; B29C 43/00; B62K 21/26

(52) U.S. Cl. 74/551.9; 264/260; 74/551.1

(57) ABSTRACT

A bicycle handlebar assembly having a stem portion constructed to engage a stem tube that is rotationally supported by a frame and a handlebar that is co-molded to the stem portion. Preferably, the stem portion and the handlebar are constructed to dissimilar materials. More preferably, the stem portion is constructed to a metal-type material and the handlebar is constructed of a carbon-fiber material. The stem portion and the handlebar are constructed such that the handlebar engages the stem portion and is secured thereto during formation of the handlebar assembly by co-molding. Such a construction provides a bicycle handlebar assembly that is lightweight, robust, and can be efficiently produced.

### BACKGROUND OF THE INVENTION

The present invention relates generally to bicycles and, more particularly, to a co-molded bicycle handlebar assembly.

The primary structural component of a conventional two-wheel bicycle is the frame. On a conventional road bicycle, the frame is typically constructed from a set of tubular members assembled together to form the frame. For many bicycles, the frame is constructed from members commonly referred to as the top tube, down tube, seat tube, seat stays and chain stays, and those members are joined together at intersections commonly referred to as the head tube, seat post, bottom bracket and rear dropout. The top tube usually extends from the head tube rearward to the seat tube. The head tube, sometimes referred to as the neck, is a short tubular structural member at the upper forward portion of the bicycle which supports the handlebar and front steering fork, which has the front wheel on it. The down tube usually extends downwardly and rearward from the head tube to the bottom bracket, the bottom bracket usually comprising a cylindrical member for supporting the pedals and chain drive mechanism which powers the bicycle. The seat tube usually extends from the bottom bracket upwardly to where it is joined to the rear end of the top tube. The seat tube also usually functions to telescopically receive a seat post for supporting a seat or saddle for the bicycle rider to sit on.

The chain stays normally extend rearward from the bottom bracket. The seat stays normally extend downwardly and rearward from the top of the seat tube. The chain stays and seat stays are normally joined together with a rear dropout for supporting the rear axle of the rear wheel. The portion of the frame defined by the head tube, seat post and bottom bracket and the structural members that join those three items together can be referred to as the main front triangular portion of the frame, with the seat stays and chain stays defining a rear triangular portion of the frame. The foregoing description represents the construction of a conventional bicycle frame.

Rider interaction and control of the bicycle is communicated to the frame of the bicycle through several structures. The handlebar assembly allows a rider to accurately control the direction of travel, the side-to-side pitch of the bicycle, and often includes other control structures such as brake handles and gear shifters. The increased popularity in recent years of off-road cycling, particularly on mountains and cross-country, has made robust handlebar constructions in many instances a biking necessity. Handlebar failure during riding would substantially jeopardize a rider's ability to control the bicycle. Accordingly a handlebar constructed for operation under such conditions must be robust.

Other handlebar assemblies have been provided which can withstand the rigors associated with such operation but such systems are not without their drawbacks. Others have simply increased the size or altered the materials of previous handlebar assemblies to accommodate the rigors associated with the off-road riding environment. Such systems also generally have a number of interconnected components. The assembly and implementation of such handlebar assemblies tends to be a labor intensive endeavor and commonly requires specialized tools to facilitate mounting the handlebar assembly to a bicycle.

Providing a handlebar assembly that includes a number of interconnected parts that are constructed of more rigid materials and/or include parts which require more material present other drawbacks. Such systems contribute to the overall weight of a bicycle assembly and are less attractive to competitive or otherwise high performance demanding riders. Many riders appreciate that the weight of the bicycle is an important consideration for rider performance.

Accordingly, it would be desirable to have a system and method of providing a bicycle handlebar assembly that is robust and lightweight. It would further be desirable to provide a handlebar assembly that can be economically manufactured and that can be simply and efficiently integrated into any of a number of bicycle configurations and/or product platforms.

### BRIEF DESCRIPTION OF THE INVENTION

The present invention provides a system and method of forming a bicycle handlebar assembly that overcomes one or more of the aforementioned drawbacks. One aspect of the invention includes a bicycle handlebar assembly having a stem portion and a pair of grip portions that are formed by a handlebar. The stem portion is constructed to engage a stem tube that is rotationally supported by a frame of the bicycle. Preferably, the stem portion and the handlebar are constructed to dissimilar materials. More preferably, the stem portion is constructed to a metal-type material, such as an aluminum or magnesium type material, and the handlebar is constructed of a carbon-fiber material. The stem portion and the handlebar are constructed such that the handlebar engages the stem portion and is secured thereto during formation of the handlebar assembly. Preferably, the handlebar is co-molded with the stem portion. More preferably, cohesion or other fastenerless means secures the handlebar to the stem portion. Such a construction provides a bicycle handlebar assembly that can withstand the rigors of cycle operation and can be quickly and efficiently integrated into a product line.

Another aspect of the invention discloses a handlebar assembly for a bicycle that includes a stem portion and a handlebar. Preferably, the stem portion and the handleabar are constructed of dissimilar materials. A cavity extends through the stem portion and is constructed to engage a portion of the one-piece body of the handlebar. The handlebar engages the cavity such that it extends beyond the opposite ends to form a first grip portion and a second grip portion. Preferably, the handlebar is co-molded with the stem portion such that the first grip portion and the second grip portion are secured to the first portion without additional fasteners.

A further aspect of the invention discloses a bicycle handlebar assembly that includes a stem section constructed to engage a stem tube and a chamber formed in the stem section. A handlebar passes through the chamber and is co-molded with the stem section such that the handlebar is fastenerlessly secured to the stem section.

Yet another aspect of the invention is disclosed as a method of forming a bicycle handlebar assembly that includes forming a handle section, forming a stem for engaging a stem tube, and co-molding the stem and the handle section to secure the handle section and the stem by cohesion.

It is appreciated that these aspects are not mutually and/or individually exclusive with respect to one another. These and various other aspects, features, and advantages of the present invention will be made apparent from the following detailed description and the drawings.

### BRIEF DESCRIPTION OF THE DRAWINGS

The drawings illustrate one preferred embodiment presently contemplated for carrying out the invention.

In the drawings:

FIG. 1 is an elevational view of the bicycle equipped with a handlebar assembly according to one embodiment of the present invention;

FIG. 2 is a perspective view of the handlebar assembly shown in FIG. 1;

FIG. 3 is a cross-sectional view of the handlebar assembly shown in FIG. 2;

FIG. 4 is an exploded view of a handlebar assembly according to another embodiment of the present invention;

FIG. 5 is a perspective view of a handlebar assembly according to a further embodiment of the present invention; and

FIG. 6 is an exploded view of the handlebar assembly shown in FIG. 5.

### DETAILED DESCRIPTION OF THE PREFERRED EMBODIMENT

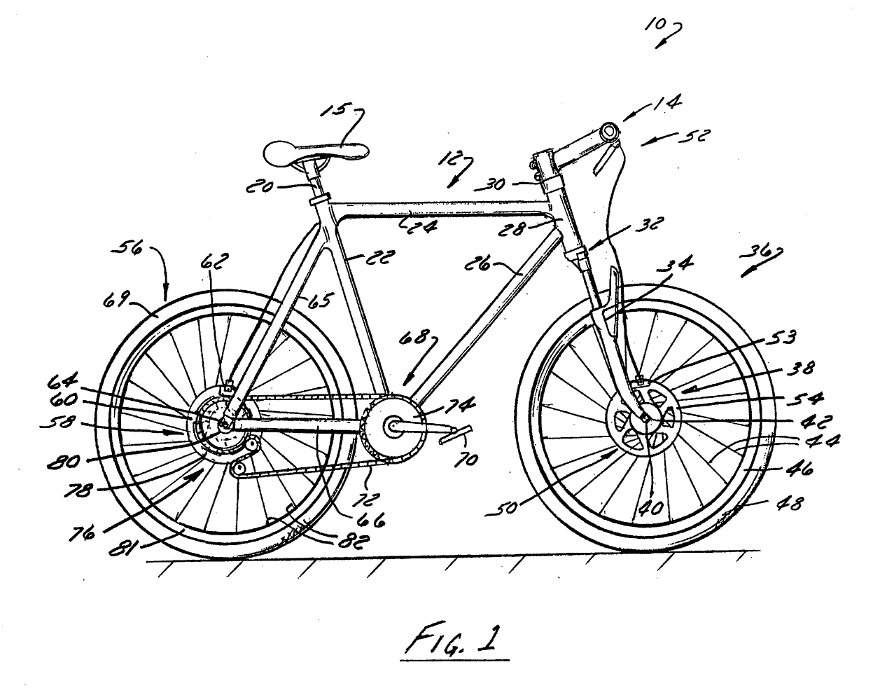

FIG. 1 shows a bicycle 10 equipped with a handlebar assembly 14 according to one embodiment of the present invention. Bicycle 10 includes a seat 15 that is preferably slideably attached to frame 12. A seat post 20 is connected to seat 15 and slidably engages a seat tube 22 of frame 12. A top tube 24 and a down tube 26 extend forwardly from seat tube 22 to a head tube 28 of frame 12. Handlebar assembly 14 is connected to a stem tube 30 that passes through head tube 28 and engages a fork crown 32. The position of handlebar assembly 14 is fixed relative to stem tube 30 and fork crown 32 such that handlebar assembly 14 and fork crown 32 rotate together relative to head tube 28.

A pair of forks 34 extend from generally opposite ends of fork crown 32 and are constructed to support a front wheel assembly 36 at an end thereof or fork tip 38. Fork tips 38 engage generally opposite sides of an axle 40 that is constructed to engage a hub 42 of front wheel assembly 36. A number of spokes 44 extend from hub 42 to a rim 46 of front wheel assembly 36. A tire 48 is engaged with rim 46 such that rotation of tire 48, relative to forks 34, rotates rim 46 and hub 42. Handlebar assembly 14 is connected to bicycle 10 such that side-to-side rotation of the handlebar assembly 14 rotations wheel assembly 36 relative to a longitudinal plane of bicycle 10.

Bicycle 10 includes a front brake assembly 50 having an actuator 52 attached to handlebar assembly 14. Brake assembly 50 includes a pair of brake pads 53 positioned on generally opposite sides of a rotor 54 secured to front wheel assembly 36. Brake rotor 54 is secured to front wheel assembly 36 proximate hub 42. Alternatively, brake pads 53 could be constructed to engage a sidewall of rim 46. Regardless of the relative engagement, brake pads 53 providing a stopping or slowing force to front wheel assembly 36. A rear wheel assembly 56 includes a disc brake assembly 58 having a rotor 60 and a caliper 62 that are positioned proximate a rear axle 64. A rear wheel 69 is positioned generally concentrically about rear axle 64. Understandably, either or both of front wheel assembly 36 and rear wheel assembly 56 could be equipped with a brake assembly generally similar to rim brake systems of disk brake systems as shown.

A seat stay 65 and a chain stay 66 offset rear axle 64 from a crankset 68. Crankset 68 includes a pedal 70 that is operationally connected to a chain 72 via a chain ring or sprocket 74. Rotation of chain 72 communicates a drive force to a rear section 76 of bicycle 10 having a gear cluster 78 positioned thereat. Gear cluster 78 is generally concentrically orientated with respect to rear axle 64 and includes a number of variable diameter gears.

Gear cluster 78 is operationally connected to a hub 80 of rear wheel 69. A number of spokes 82 extend radially between hub 80 and a rim 81 of rear wheel 69 of rear wheel assembly 56. As is commonly understood, rider operation of pedals 70 drives chain 72 thereby driving rear wheel 69 which in turn propels the rider of bicycle 10. The full weight and force of the rider is communicated to frame 12 of bicycle 10 through peddles 70, seat 15, and handlebar assembly 14. During aggressive riding, the rider occasionally assumes an elevated position such that only peddles 70 and handlebar assembly 14 support rider interaction with bicycle 10.

FIG. 2 shows handlebar assembly 14 removed from bicycle 10. Handlebar assembly 14 includes a first portion or stem section 86 and a unitary handle section or handlebar 89 that extends through stem section 86 and includes a pair of grip areas or grip portions 112. Stem section 86 includes a first passage or stem opening 92 formed at a first end 94 and a second passage, chamber, cavity, or handlebar opening 96 formed at a second end 98. A pair of arms 100, 102 form stem opening 92 and slidably engage stem tube 30 of a bicycle 10 as shown in FIG. 1. A pair of fasteners 104 cooperate with each arm 100, 102 for clamping the arms 100, 102 about stem tube 30.

An axis 106 of stem opening 92 is oriented in a generally crossing direction with an axis 108 of handlebar opening 96. A passage 110 extends through stem section 86, is in fluid communication with handlebar opening 96, and is oriented in a crossing direction with axis 106 of stem opening 92 and axis 108 of handlebar opening 96. Preferably, stem section 86 is constructed to a metal-type material and, more preferably, stem section 86 is three dimensionally forged or machined from an aluminum type material. Such a construction has been shown to provide a handlebar stem section that withstands aggressive riding and weighs approximately 100 grams. Understandably, weights and configurations other than those shown are envisioned. For example, axis 106 could be canted relative to axis 108 to provide alternate handlebar configurations and orientations relative to frame 12.

Handlebar 89 is preferably a one-piece component that extends generally continuously between generally oppositely extending grip portions 112. More preferably, handlebar 89 is constructed of a carbon-fiber type material wherein carbon fibers extend generally continuously between the oppositely facing grip portions 112 and extend across stem section 86 through handlebar opening 96. Handlebar 89 is co-molded with stem section 86 such that a cohesion is formed at the interface between stem section 86 and handlebar 89. Such a construction permanently secures handlebar 89 to stem section 86 without additional fasteners or user operable clamping systems. Cohesively securing handlebar 89 to stem section 86 ensures that handlebar 89 is fastenerlessly secured to stem section 86 and unable to pivot, slide, or otherwise move relative to the stem section 86. It is appreciated that such a construction could also be achieved by bonding handlebar 89 to stem section 86 post the molding process.

Although stem section 86 and handlebar 89 are disclosed as being preferably formed of different or dissimilar materials, it is appreciated that handlebar assembly 14 may be provided with handlebar 89 and stem section 86 being formed of similar materials. That is, it is appreciated that handlebar 89 and stem section 86 could both be formed of a similar material, such as a carbon fiber material, and wherein the handlebar 89 is co-molded to the stem section such that the two components are cohesively secured to one another.

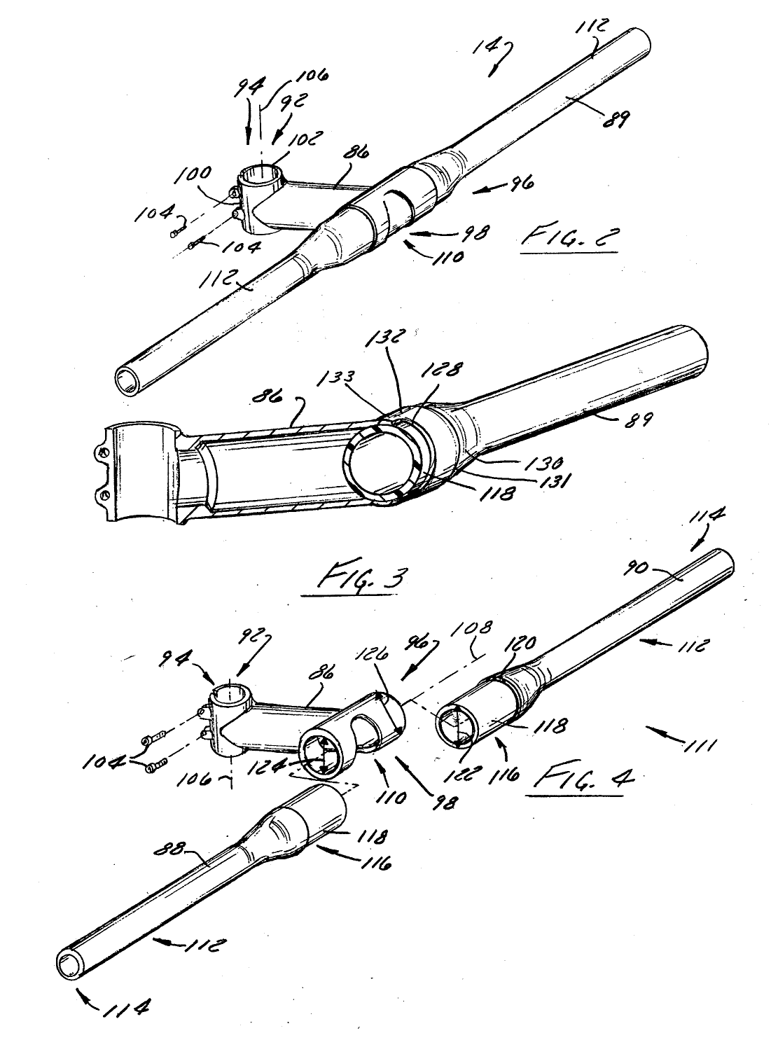

As shown in FIG. 3, when assembled, stem section 86 and handlebar 89 are constructed to provide a generally continuous and fluid outer contour. Preferably, handlebar 89 are formed of a carbon based material and is preferably formed of a carbon fiber material. Handlebar 89, having a total weight of approximately 127 grams, has been shown to withstand the rigors of operation of a bicycle over rough terrain.

Stem section 86 and handlebar 89 are co-molded such that a cohesion or a film adhesion is formed at an interface 128 between stem section 86 and handlebar 89. It is appreciated that the cohesion between the handlebar and the stem could be provided through use of epoxies or other bonding agents that are integrated into or separate from the stem and/or handlebar, third part bonding agents, agents that partially penetrate the structure of the handlebar and/or stem, and/or film adhesion bonding between the handlebar and the stem with or without utilization of extraneous bonding agents. The cohesion between handlebar 89 and stem section 86 permanently secures handlebar 89 relative to stem section 86. Furthermore, during co-molding, when formed of an aluminum material, the aluminum based material of stem section 86 shrinks about the stem area 118 of handlebar 89 and further enhances the fixed connection between stem section 86 and handlebar 89. Even so, cohesion or film adhesion preferably secures handlebar 89 to stem section 86 in a permanent and fastenerless manner. Furthermore, the relatively thin-walled construction of stem section 86 and handlebar 89 provide a lightweight and robust handlebar assembly 14.

As shown in FIG. 3, handlebar 89 includes an optional rib 130 that is formed proximate the opposing terminal ends 131 of stem section 86. Rib 130 is construction to generally correspond with an outer diameter 133 of stem section 86 to provide a relatively smooth and generally continuous outer contour of handlebar assembly 14. Ribs 130 also assist in orienting handlebar 89 relative to stem section 86 during co-molding and ensure that handlebar 89 is generally centrally disposed within handlebar opening 96 of stem section 86.

FIG. 4 shows an alternate embodiment of a handlebar assembly 111 according to the present invention. As shown in FIG. 4, the construction of handlebar assembly 111 is generally similar to the construction of handle bar assembly 14. Accordingly, like reference numerals are used to reference elements of the construction of handle assembly 111 that are substantially similar to handlebar assembly 86. For instance, stem section 86 may be generally identical between handlebar assembly 14 and handlebar assembly 111. However, handlebar assembly 111 includes a pair of handle portions 88, 90 that are each independently engageable with stem section 86 rather than a single handlebar having a pair of grip portions such as handlebar 89.

Each handle section 88, 90 of handlebar assembly 111 includes a grip portion 112 positioned between a first end 114 and a second end 116 of each respective handle section 88, 90. A stem area 118 is formed proximate the second end 116 of each handle section 88, 90. Each stem area 118 is constructed to be received within handlebar opening 96 of stem section 86 and secured thereto preferably during a co-molding process. A optional rib 120 is formed on each handle section 88, 90 proximate stem area 118. An outer diameter, indicated by arrow 122, of each stem area 118 of handle sections 88, 90, is only somewhat similar to a diameter, indicated by arrow 124, of handlebar opening 96. At ambient temperature, if left separated, the outer diameter 124 of handlebar opening 96 is smaller than the outer diameter 122 of stem areas 118 of handle sections 88, 90. When assembled this construction provides a clamping force between stem section 86 and handle sections 88, 90 even though handle sections 88, 90 are each cohesively secured to stem section 86.

Similar to handlebar assembly 14, it is appreciated that stem section 86 and handle sections 88, 90 could be provided as similar or dissimilar materials. Preferably, handle sections 88, 90 are formed of a carbon fiber material and stem section 86 is formed of a metal material such as aluminum or magnesium. It is appreciated that any of stem section 86 and handle sections 88, 90 be formed of carbon fiber or metal based materials. Regardless of the material of the respective elements, handle sections 88, 90 and stem section 86 are secured via cohesion and preferably secured together during co-molding.

An outer diameter of handle sections 88, 90 proximate rib 120 is generally similar to an outer diameter, indicated by arrow 126, of stem section 86 proximate handlebar opening 96. As shown in FIG. 4, when assembled, stem section 86 and handle sections 88, 90 are constructed to provide a generally continuous and fluid outer contour.

Preferably, stem section 86 and handle sections 88, 90 are co-molded such that film adhesion at the interface 128 between stem section 86 and handle sections 88, 90 permanently secures handle sections 88, 90 relative to stem section 86. Cohesion or film adhesion secures handle sections 88, 90 to stem section 86 in a permanent and fastenerless manner. Furthermore, the relatively thin-walled construction of stem section 86 and handle sections 88, 90 provides a lightweight and robust handlebar assembly 111 that can withstand the rigors of the most aggressive riding.

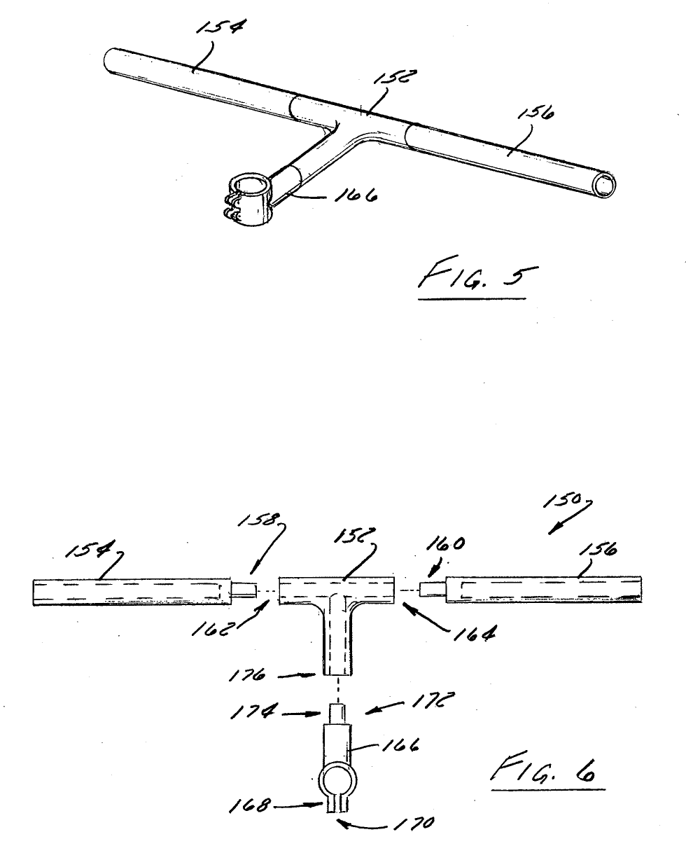

FIGS. 5 and 6 show another embodiment of a handlebar assembly 150 according to the present invention. Handlebar assembly 150 includes a center section 152, a first handle section 154 and a second handle section 156. Each handle section 154, 156 includes a projection 158, 160 constructed to slidably engage a cavity 162, 164 formed in generally opposite ends of center section 152. A stem section 166 includes a clamp body 168 disposed at one end 170 thereof and a projection 172 extending from an opposite end 174 thereof. Projection 172 is constructed to slidably engage a cavity 176 formed in center section 152.

Handle sections 154, 156 are constructed of a carbon fiber type material and one or more of center section 152 and stem section 166 may be constructed of a metal based or aluminum-type material. Center section 152, stem section 166, and handle sections 154, 156 are constructed to be co-molded such that handlebar assembly 150 can be formed without additional fasteners. Each of center section 152, stem section 166, and handle sections 154, 156 are constructed to be secured to one another by film adhesion between the interface of the respective components. Furthermore, the interface between center section 152 and stem section 166 allows handlebar assembly 150 to be tailored to cooperate with any of a number of stem constructs, configurations, and orientations. That is, handlebar assembly 150 can be easily adapted to cooperate with a number of bicycles across a product platform by easily and efficiently providing a variety of stem section configurations.

The generally uniform and fluid exterior surface of both handlebar assembly 14 and handlebar assembly 150 provide a handlebar assembly that is esthetically pleasing and versatile. The omission of extraneous fasteners simplifies the construction and integration of handlebar assemblies 14, 150 with a bicycle. The compound material of the respective components of handlebar assemblies 14, 150 further provide handlebar assemblies that are robust and lightweight.

Therefore, a handlebar assembly according an embodiment of the invention includes a handlebar and a stem section that are secured together by cohesion. Preferably, the handlebar is a unitary element that includes a pair of grip portions which extend from generally opposite ends of an engagement between the stem section and the handlebar. Preferably, the handlebar is constructed of a carbon fiber material and the stem may be constructed of a like or dissimilar material. The stem section and the handlebar are preferably co-molded together to form a one-piece handlebar assembly that includes grip portions and a stem tube engaging area. Such a construction provides a lightweight and robust handlebar assembly.

The present invention has been described in terms of the preferred embodiments, and it is recognized that equivalents, alternatives, and modifications, aside from those expressly stated, are possible and within the scope of the appending claims. It is further understood and appreciated that that the various aspects, features, and embodiments disclosed herein are not solely or mutually exclusive.

What is claimed is:

1. A handlebar assembly for a bicycle comprising:
a first portion constructed of a first material for engaging a stem of a bicycle;
a cavity extending through the first portion to generally opposite ends thereof; and
a handlebar section constructed of a second material that is different than the first material, the handlebar section having a one-piece body that extends beyond the opposite ends to form a first grip portion and a second grip portion, the handlebar section being co-molded with the first portion such that the first grip portion and the second grip portion are secured to the first portion without additional fasteners.

2. The handlebar assembly of claim 1 further comprising a land formed on the handlebar section proximate each end of the first portion, each land constructed to generally abut a terminal face of the first portion proximate each end.

3. The handlebar assembly of claim 1 wherein the first portion is constructed of an aluminum based material and the handlebar section is constructed of a carbon fiber type material.

4. The handlebar assembly of claim 3 wherein the cavity is sized to constrict about the handlebar section during formation of the handlebar assembly so that that the first and second grip portions are fastenerlessly permanently secured to the first portion.

5. The handlebar assembly of claim 3 wherein the handlebar section is secured to the first portion by film adhesion.

6. The handlebar assembly of claim 1 wherein the handlebar section includes a number of common carbon fibers that extend between the first grip portion and the second grip portion.

7. The handlebar assembly of claim 1 wherein a majority of a longitudinal length of the handlebar section is hollow cored.

8. A bicycle handlebar assembly comprising:
a stem section constructed to engage a stem tube;
a chamber formed in the stem section;
a handlebar passing through the chamber and co-molded with the stem section such that the handlebar is fastenerlessly secured the to the stem section.

9. The bicycle handlebar assembly of claim 8 wherein at least one of the stem section and handlebar is formed of at least one of a carbon fiber material, a metal material, an aluminum material, and a magnesium material.

10. The bicycle handlebar assembly of claim 9 wherein the stem section and the handlebar are formed of dissimilar materials and the stem section is formed of the metal material and the handlebar is formed of the carbon fiber material.

11. The bicycle handlebar assembly of claim 10 wherein the handlebar includes a first grip portion and a second grip portion positioned on generally opposite sides of the stem section.

12. The bicycle handlebar assembly of claim 8 further comprising a pair of ribs formed on the handlebar and wherein an outer diameter of each rib is generally similar to an outer diameter of the stem section proximate the chamber.

13. The bicycle handlebar assembly of claim 8 further comprising a stem clamp formed in the stem section for engaging the stem tube, the stem clamp being oriented in a crossing direction with respect to an orientation of the handlebar.

14. The bicycle handlebar assembly of claim 8 wherein the handlebar is one of bifurcated to include a first portion and a second portion and a unitary body extending beyond each end of the chamber.

15. The bicycle handlebar assembly of claim 8 further comprising forming a cohesion between an interface of the stem section and handlebar.

16. The bicycle handlebar assembly of claim 15 further comprising an opening formed in the stem section proximate the chamber and oriented generally transverse to a longitudinal axis thereof.

17. The bicycle handlebar assembly of claim 8 wherein the handlebar assembly weighs less than approximately 250 grams.

18. A method of forming a bicycle handlebar assembly comprising:
forming a handle section;
forming a stem for engaging a stem tube; and
co-molding the stem and the handle section to secure the handle section and the stem by cohesion.

19. The method of claim 18 further comprising forming a cavity through a majority of the handle section and the stem.

20. The method of claim 19 further comprising forming the handle section and the stem from dissimilar materials.

21. The method of claim 18 wherein the cohesion is provided by film adhesion at contact surfaces between the handle section and the stem.
